(19) United States
(12) Patent Application Publication
(10) Pub. No.: US 2024/0305158 A1
(43) Pub. Date: Sep. 12, 2024

(54) INSTALLING AND SEALING MECHANISM FOR DRIVING MOTOR OF SWIMMING POOL ROBOTS

(71) Applicant: Shenzhen Seauto Technology Co., Ltd., Shenzhen, Guangdong (CN)

(72) Inventor: ZHUOMING DENG, Shenzhen (CN)

(21) Appl. No.: 18/011,081

(22) PCT Filed: Oct. 24, 2022
(86) PCT No.: PCT/CN2022/126875

§ 371 Date: Dec. 16, 2022

(30) Foreign Application Priority Data
Oct. 17, 2022 (CN) 202222725360.0

(51) Int. Cl. F16J 15/40; F16J 15/3248

(52) U.S. Cl. CPC F16J 15/40; F16J 15/3248

(57) ABSTRACT

The present invention provides an installing and sealing mechanism configured for a driving motor of a swimming pool robot, which comprising a sealing housing and a driving motor, two sides of the sealing housing are integrally provided with a sealed fixing seat, and a sealing member is mounted on an outer side of the sealed fixing seat, one of the sealed fixing seat and the sealing member is provided with a sealing groove for installing sealing strips, and the central part of the sealing member is provided with a sealing cavity, for installing an oil seal, the driving motor is mounted inside the sealing housing, and a motor output shaft of the driving motor penetrates through the sealing housing and the sealing member. the sealing member is fixed in the sealed fixing seat through the bolt holes in the fixing, so that the bottom of the round fixing seat abuts against and closely contacts the sealing strip installed in the sealing groove, and a closed space is formed in the sealed fixing seat, a large amount of lubricating oil is filled in the sealed cavity to form an oil seal, thereby achieving the purpose of sealing and effectively preventing leakage.

### TECHNICAL FIELD

The present disclosure relates to the technical field of swimming pool robots, specifically relates to an installing and sealing mechanism for driving motor of swimming pool robots.

### BACKGROUND ART

The swimming pool cleaning robots are automatic device capable of autonomously finishing the cleaning work of the bottom of the swimming pool under water. The cleaning robots help cleaning up daily trash and dirt at the bottom of swimming pool, completely change the traditional method of manual cleaning, By utilizing the cleaning robots, the cleaning work may no longer be troublesome. In order to realize the function of autonomously cleaning under water, in addition to good water-proof performance, the robot also needs “eyes” capable of route recognition, and path navigation. Generally, navigation systems in similar applications use a measurement method in which an acceleration sensor and a gyroscope are combined to acquire a trajectory of a moving object, so as to control the movement trend of the cleaning robots.

In order to realize the function of autonomously cleaning under water, in addition to the path navigation system for the cleaning robot, the cleaning robot also needs to have good waterproof property, especially a driving part of the robot. A drive motor of a swimming pool robot is traditionally mounted inside the housing thereof, and then an output shaft penetrates through the housing and the output shaft is coated with lubricating oil at the penetrating position. Such a mounting method can easily cause leakage and irreparable damage to the swimming pool robot.

### SUMMARY OF DISCLOSURE

The present invention provides an installing and sealing mechanism for driving motor of swimming pool robots to solve the disadvantages existing in the prior art.

In order to achieve the above object, the present invention adopts the following technical solutions: an installing and sealing mechanism configured for driving a motor of a swimming pool robot, the installing and sealing mechanism comprising a sealing housing and a driving motor, wherein two sides of the sealing housing are integrally formed with sealed fixing seats, respectively, and a sealing member is mounted on an outer side of each of the sealed fixing seats, one of the sealed fixing seats and the sealing member is provided with a sealing groove for installing sealing strips, and a central part of the sealing member is provided with a sealing cavity for installing an oil seal, the sealing housing is configured to mount the driving motor therein with, such that a motor output shaft of the driving motor penetrates through the sealing housing and the sealing member.

Preferably, an inner part of the sealing housing is integrally formed with a motor mounting seat, the motor mounting seat is correspondingly positioned relative to the sealed fixing seats, and the motor mounting seat fixedly mounts the driving motor inside the sealing housing.

Preferably, a peripheral surface of each of the sealed fixing seats is integrally formed with a screw fixing pillar, and a bottom of the screw fixing pillar is integrally connected with the sealing housing, each of the seal fixing seats comprises motor fixing holes evenly distributed surrounding an axis of the motor output shaft as a circle center, each of the motor fixing holes penetrates through the motor mounting seat, and a first motor shaft hole is provided at a center of the sealed fixing seat, the first motor shaft hole rotatably accommodates the motor output shaft to extend through, and connections between the first motor shaft hole and the motor output shaft are sealed, and the sealing member is fixedly mounted to the sealing housing by a screw fixing pillar.

Preferably, the sealing member comprises a round fixing seat and a second motor shaft hole is fixed and pressed with each of the sealed fixing seats is integrally connected to a peripheral surface of the round fixing seat are provided at an end of the fixing pins away from the round fixing seat are aligned with the screw fixing pillars is provided inside the round fixing seat extend through the sealed cavity rotatably accommodates and connects with the motor output shaft.

Preferably, the round fixing seat is pressed inside the sealed fixing seat by a screw, a diameter of the round fixing seat is smaller than an inner diameter of the sealed fixing seat, and a bottom of the round fixing seat abuts against the sealing strip installed in the sealing groove.

Preferably, a fixing screw is provided in the motor fixing hole, and a fixing bolt fixedly connects the driving motor to the motor fixing hole by a threaded connection. Preferably, fixing pins are five connecting rods uniformly arranged with an axis of the round fixed seat as a center, an angle between adjacent fixed pins is 72 degrees, and a reinforcing rib is integrally provided on a body side of the fixed pins.

### FEATURE EFFECTS OF DISCLOSURE

Compared with the prior art, the ADVANTAGEOUS EFFECTS of the present invention are followings:
in the installing and sealing mechanism configured for driving motor, the sealing member is fixed in the sealed fixing seat by setting a sealed fixing seat outside the sealing housing and setting a sealing groove mounted with a sealing ring on the sealed fixing seat, the sealing member is fixed in the sealed fixing seat through the bolt holes in the fixing pins, so that the bottom of the round fixing seat abuts against and closely contacts the sealing strip installed in the sealing groove, and a closed space is formed in the sealed fixing seat, an oil seal is mounted in the sealed cavity by filling in a large amount of lubricating oil; and the first motor shaft hole rotatably connected to the motor output shaft is separated from the second motor shaft hole by the lubricating oil thereby achieving the purpose of sealing and effectively preventing leakage.

### BRIEF DESCRIPTION OF DRAWINGS

FIG. 1 is an integral structural schematic diagram of an installing and sealing mechanism for driving motor of swimming pool robots according to the present disclosure;

FIG. 2 is a structural schematic diagram of a sealed fixing seat of an installing and sealing mechanism for driving motor of swimming pool robots according to the present disclosure;

FIG. 3 is a structural schematic diagram of a sealing element of an installing and sealing mechanism for driving motor of swimming pool robots according to the present disclosure.

FIG. 4 is another structural schematic diagram of the sealing element of an installing and sealing mechanism for driving motor of swimming pool robots according to the present disclosure.

FIG. 5 is a section view of an installing and sealing mechanism for driving motor of swimming pool robots according to the present disclosure;

FIG. 6 is an enlarged view of circled portion A in FIG. 5 of the installing and sealing mechanism for driving motor of swimming pool robots according to the present disclosure.

### DESCRIPTION OF EMBODIMENTS

Hereinafter, the technical solutions in the embodiments of the present invention will be described clearly and completely with reference to the drawings of the embodiments of the present invention. Obviously, the embodiments described are only partial embodiments of the present invention, rather than all of the embodiments. Based on the embodiments of the present invention, all other embodiments obtained by those skilled in the art without creative efforts all belong to the scope of protection of the present invention.

### EMBODIMENTS

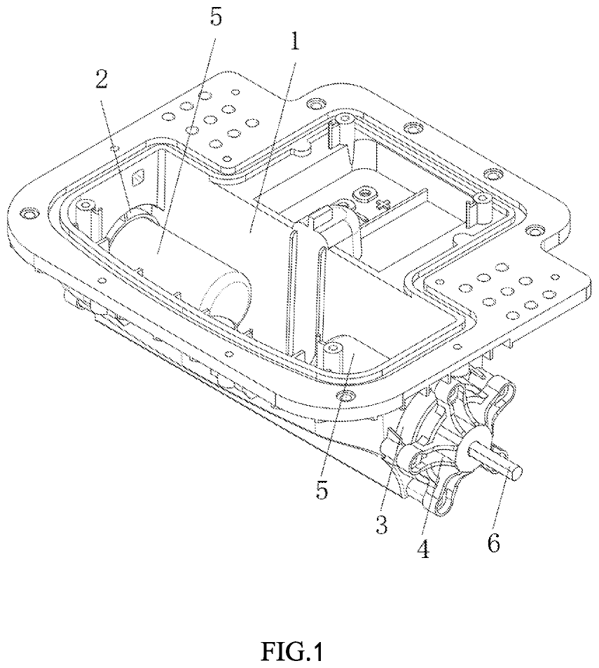

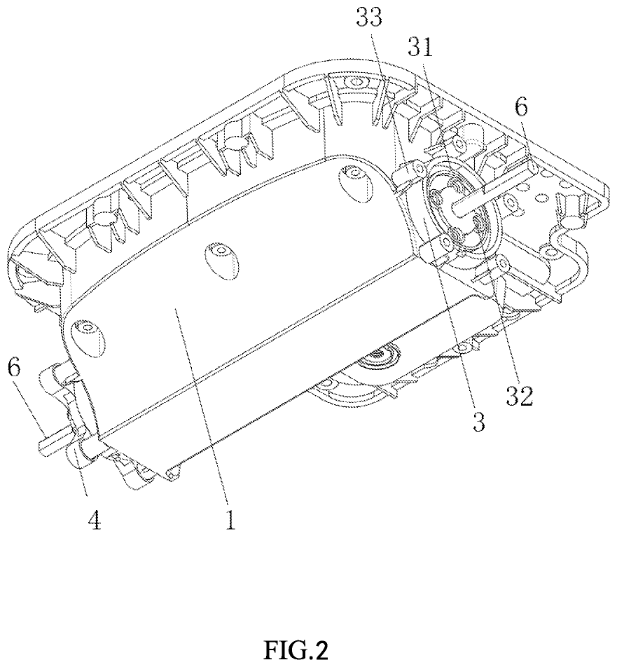

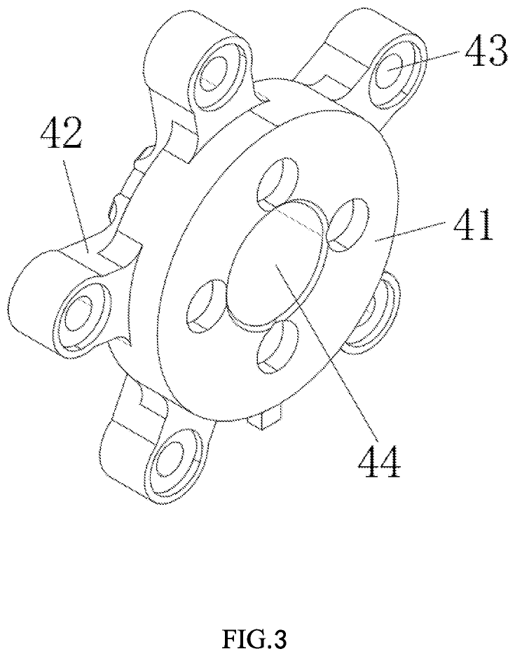

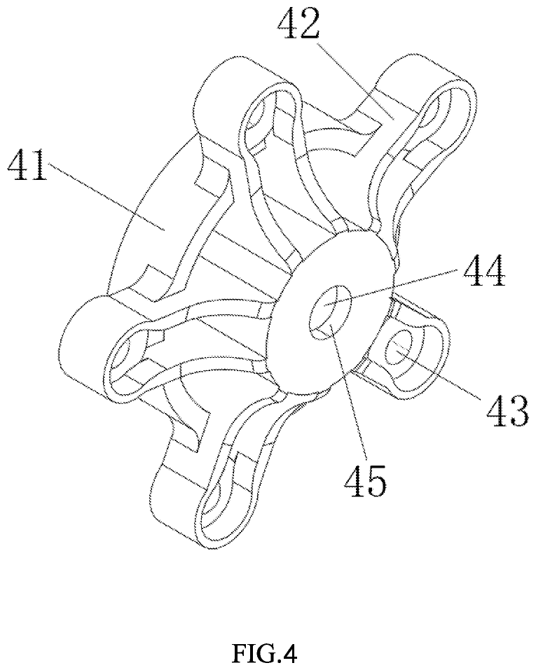

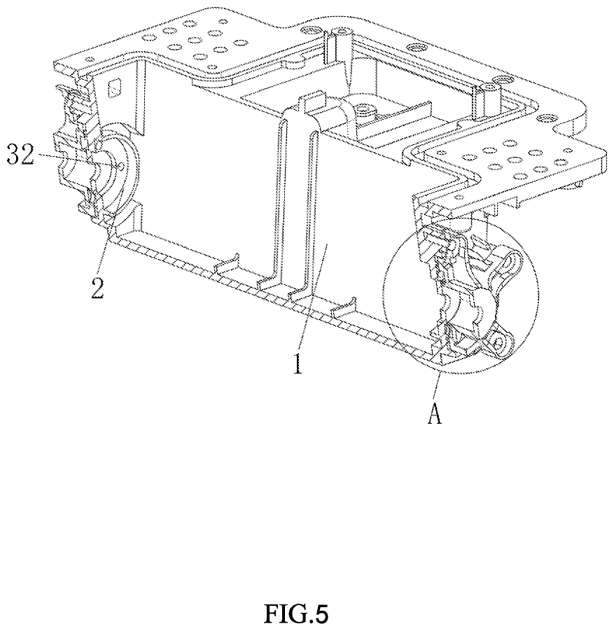

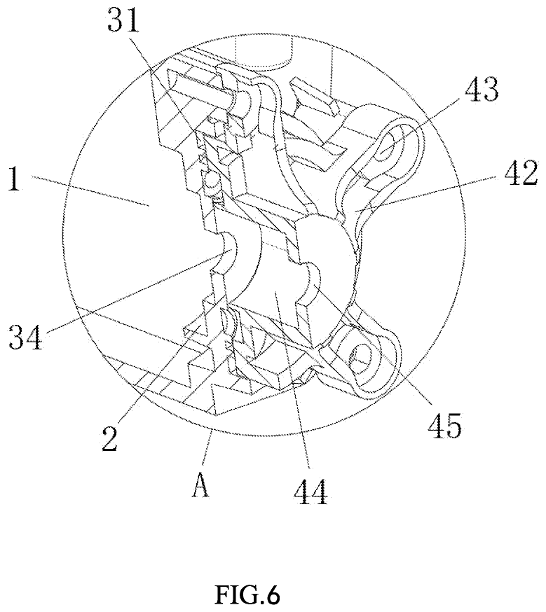

Referring to FIGS. 1 to 6, the present invention provides an installing and sealing mechanism configured for a driving motor of a swimming pool robot, which comprising a sealing housing 1 and a driving motor 5, two sides of the sealing housing 1 are integrally formed with sealed fixing seats 3 respectively, and a sealing member 4 is mounted on an outer side of each of the sealed fixing seats 3, one of the sealed fixing seat 3 and the sealing member 4 is provided with a sealing groove 31 for installing sealing strips, and the central part of the sealing member 4 is provided with a sealing cavity 44 for installing an oil seal, the sealing housing is configured to mount the driving motor therein with, such that a motor output shaft 6 of the driving motor 5 penetrates through the sealing housing 1 and the sealing member 4, the sealing member 4 is fixed in the sealed fixing seat 3 by setting a sealed fixing seat 3 outside the sealing housing 1 and setting a sealing groove 31 mounted with a sealing ring on the sealed fixing seat 3, the sealing member 4 is fixed in the sealed fixing seat 3 through the bolt holes 43 in the fixing pins 42, so that the bottom of the round fixing seat 41 abuts against and closely contacts the sealing strip installed in the sealing groove 31, and a closed space is formed in the sealed fixing seat 3 to prevent leakage.

An inner part of the sealing housing 1 is integrally formed with a motor mounting seat 2, the motor mounting seat 2 is correspondingly positioned relative to the sealed fixing seats 3, and the motor mounting seat fixedly mounts the driving motor 5 inside the sealing housing.

a peripheral surface of each of the sealed fixing seats 3 is integrally formed with a screw fixing pillar 33, and a bottom of the screw fixing pillar 33 is integrally connected with the sealing housing 1, each of the seal fixing seats comprises motor fixing holes 32 evenly distributed surrounding an axis of the motor output shaft 6 as a circle center, each of the motor fixing holes 32 penetrates through the motor mounting seat 2, and a first motor shaft hole 34 is provided at a center of the sealed fixing seat 3, the first motor shaft hole 34 rotatably accommodates the motor output shaft 6 to extend through, and connections between the first motor shaft hole 34 and the motor output shaft are sealed, and the sealing member 4 is fixedly mounted to the sealing housing 1 by a screw fixing pillar 33.

The sealing member 4 comprises a round fixing seat 41, a fixing pin 42, a bolt hole 43, a sealing cavity 44 and a second motor shaft hole 45, the round fixing seat 41 is fixed and pressed with the sealing fixing base 3, and the fixed pin 42 is integrally connected to the peripheral surface of the round fixing seat 41, the bolt holes 43 are provided at an end of the fixing pins 42 away from the round fixing seat 41, and the bolt holes 43 are aligned with the screw fixing pillars 33, the sealed cavity 44 is provided inside the round fixing seat 41, an oil seal is mounted inside the sealed cavity 44, and the second motor shaft hole 45 penetrates the sealed cavity 44, the motor output shaft 6 is connected with the second motor shaft hole 45 in a sealing and rotating manner, a large amount of lubricating oil is filled in the sealed cavity 44 to form an oil seal; and the first motor shaft hole 34 rotatably connected to the motor output shaft 6 is separated from the second motor shaft hole 45 by the lubricating oil, thereby achieving the purpose of sealing and effectively preventing leakage.

The round fixing seat 41 is pressed inside the sealed fixing seat 3 by a screw, the diameter of the round fixing seat 41 is smaller than the inner diameter of the sealed fixing seat 3, and the bottom of the round fixing seat 41 abuts against the sealing strip installed in the sealing groove 31.

A fixing screw is provided in the motor fixing hole 32, and a fixing bolt in the motor fixing hole 32 is fixedly connected to the driving motor 5 by threaded connection.

The fixed pins 42 are five connecting rods uniformly arranged by taking the axis of the round fixed seat 41 as the center of a circle, the angle between adjacent fixed pins is 72 degrees, and a reinforcing rib is integrally provided on the body side of the fixed pins.

The working principle is as follows: the sealing member 4 is fixed in the sealed fixing seat 3 by setting a sealed fixing seat 3 outside the sealing housing 1 and setting a sealing groove 31 mounted with a sealing ring on the sealed fixing seat 3, the sealing member 4 is fixed in the sealed fixing seat 3 through the bolt holes 43 in the fixing pins 42, so that the bottom of the round fixing seat 41 abuts against and closely contacts the sealing strip installed in the sealing groove 31, and a closed space is formed in the sealed fixing seat 3, an oil seal is mounted in the sealed cavity 44 by filling in a large amount of lubricating oil; and the first motor shaft hole 34 rotatably connected to the motor output shaft 6 is separated from the second motor shaft hole 45 by the lubricating oil, thereby achieving the purpose of sealing and effectively preventing leakage.

Although embodiments of the present invention have been shown and described, it would be appreciated by those skilled in the art that changes, modifications, alternatives and modifications can be applied to these embodiments without departing from the principle and spirit of the present invention, and the scope of the present invention is defined by the claims and their equivalents.

### REFERENCE SIGNS LIST

1 Sealing Housing
2 Motor Mounting Seat
3 Scaled Fixing Scat
31 Scaling Groove
32 Motor Fixing Hole
33 Screw Fixing Pillar
34 First Motor Shaft Hole
4 Scaling Member
41 Round Fixing Seat
42 Fixing Pin
43 Bolt Hole
44 Scaling Cavity
45 Second Motor Shaft Hole
5 Driving Motor
6 Motor Output Shaft

What is claimed is:

1. An installing and sealing mechanism configured for driving a motor of a swimming pool robot, the installing and sealing mechanism comprising a sealing housing (1) and a driving motor (5), wherein two sides of the sealing housing (1) are integrally formed with sealed fixing seats (3), respectively, and a sealing member (4) is mounted on an outer side of each of the sealed fixing seats (3), one of the sealed fixing seats (3) and the sealing member (4) is provided with a sealing groove (31) for installing sealing strips, and a central part of the sealing member (4) is provided with a sealing cavity (44) for installing an oil seal, the sealing housing (1) is configured to mount the driving motor therein with, such that a motor output shaft (6) of the driving motor (5) penetrates through the sealing housing (1) and the sealing member (4).

2. The installing and sealing mechanism according to claim 1, wherein an inner part of the sealing housing (1) is integrally formed with a motor mounting seat (2), the motor mounting seat (2) is correspondingly positioned relative to the sealed fixing seats (3), and the motor mounting seat fixedly mounts the driving motor (5) inside the sealing housing.

3. The installing and sealing mechanism according to claim 2, wherein a peripheral surface of each of the sealed fixing seats (3) is integrally formed with a screw fixing pillar (33), and a bottom of the screw fixing pillar (33) is integrally connected with the sealing housing (1), each of the seal fixing seats comprises motor fixing holes (32) evenly distributed surrounding an axis of the motor output shaft (6) as a circle center, each of the motor fixing holes (32) penetrates through the motor mounting seat (2), and a first motor shaft hole (34) is provided at a center of the sealed fixing seat (3), the first motor shaft hole (34) rotatably accommodates the motor output shaft (6) to extend through, and connections between the first motor shaft hole (34) and the motor output shaft are sealed, and the sealing member (4) is fixedly mounted to the sealing housing (1) by a screw fixing pillar (33).

4. The installing and sealing mechanism according to claim 3, wherein the sealing member (4) comprises a round fixing seat (41), a fixing pin (42), a bolt hole (43), a sealing cavity (44) and a second motor shaft hole (45), the round fixing seat (41) is fixed and pressed with each of the sealed fixing seats (3), and the fixed pin (42) is integrally connected to a peripheral surface of the round fixing seat (41), the bolt holes (43) are provided at an end of the fixing pins (42) away from the round fixing seat (41), and the bolt holes (43) are aligned with the screw fixing pillars (33), the sealed cavity (44) is provided inside the round fixing seat (41), an oil seal is mounted inside the sealed cavity (44), and the second motor shaft hole (45) extend through the sealed cavity (44), the second motor shaft hole (45) rotatably accommodates and connects with the motor output shaft (6).

5. The installing and sealing mechanism according to claim 4, wherein the round fixing seat (41) is pressed inside the sealed fixing seat (3) by a screw, a diameter of the round fixing seat (41) is smaller than an inner diameter of the sealed fixing seat (3), and a bottom of the round fixing seat (41) abuts against the sealing strip installed in the sealing groove (31).

6. The installing and sealing mechanism according to claim 3, wherein a fixing screw is provided in the motor fixing hole (32), and a fixing bolt fixedly connects the driving motor (5) to the motor fixing hole by a threaded connection.

7. The installing and sealing mechanism according to claim 4, wherein the fixing pins (42) are five connecting rods uniformly arranged with an axis of the round fixed seat (41) as a center, an angle between adjacent fixed pins (42) is 72 degrees, and a reinforcing rib is integrally provided on a body side of the fixed pins (42).
